(19) United States
(12) Patent Application Publication
(10) Pub. No.: US 2013/0084179 A1
(43) Pub. Date: Apr. 4, 2013

(54) VARIABLE VANE ANGULAR POSITION SENSOR

(71) Applicants: Joseph V. Mantese, Ellington, CT (US); Dustin Frame, Glastonbury, CT (US); Richard A. Poisson, Avon, CT (US); William E. Rhoden, Glastonbury, CT (US)

(72) Inventors: Joseph V. Mantese, Ellington, CT (US); Dustin Frame, Glastonbury, CT (US); Richard A. Poisson, Avon, CT (US); William E. Rhoden, Glastonbury, CT (US)

(73) Assignee: HAMILTON SUNDSTRAND CORPORATION, Windsor Locks, CT (US)

(21) Appl. No.: 13/250,396

(22) Filed: Sep. 30, 2011

(51) Int. Cl. F02C 9/22; F02C 7/00

(52) U.S. Cl. 416/1; 416/31

(57) ABSTRACT

A variable vane control system for use with a gas turbine engine includes an actuator, a mechanical linkage assembly, and a vane position sensor. The gas turbine engine has a plurality of variable vanes each having an airfoil disposed in a gas flow path of the gas turbine engine. The plurality of variable vanes includes a first variable vane. The mechanical linkage assembly operably connects the actuator to at least the first variable vane. The vane position sensor is connected to one of the first variable vane or a portion of the mechanical linkage assembly proximate the first variable vane for sensing angular position of the first variable vane.

### BACKGROUND

The present invention relates to gas turbine engines, and in particular, to positioning variable vanes on gas turbine engines. In some gas turbine engines, variable vanes are used to adjust the angle of air flow into turbine and compressor sections. This is typically accomplished using an actuator to rotate the variable vanes via a mechanical linkage. A sensor is often integrated with or connected to the actuator to provide feedback on the position of the actuator.

Such systems do not, however, provide feedback on the angular position of the variable vanes. Because of errors in each link between the actuator and the variable vane, the position of the actuator may not be indicative of the position of the variable vane. Uncertainties in the angular position of variable vanes have lead engine designers to build additional margin into engine designs, leading to un-optimized fuel burn efficiencies, performance reductions due to compensation with turbine stage design, and premature engine repair.

### SUMMARY

According to the present invention, a variable vane control system for use with a gas turbine engine includes an actuator, a mechanical linkage assembly, and a vane position sensor. The gas turbine engine has a plurality of variable vanes each having an airfoil disposed in a gas flow path of the gas turbine engine. The plurality of variable vanes includes a first variable vane. The mechanical linkage assembly operably connects the actuator to at least the first variable vane. The vane position sensor is connected to one of the first variable vane or a portion of the mechanical linkage assembly proximate the first variable vane for sensing angular position of the first variable vane.

Another embodiment of the present invention is a method for operating a variable vane control system for use with a gas turbine engine. The method includes rotating a first variable vane via an actuator mechanically connected to the first variable vane, sensing angular position of the first variable vane via a vane position sensor fixedly attached to the first variable vane, and adjusting angular position of the first variable vane based on a position signal from the vane position sensor. The position signal represents sensed angular position of the first variable vane.

### BRIEF DESCRIPTION OF THE DRAWINGS

FIG. 1 is a schematic side view of a gas turbine engine.

FIG. 2 is a perspective view of a portion of a compressor section including a variable vane control system.

FIG. 3A is a schematic side sectional view of a variable vane and the variable vane control system of FIG. 2.

FIG. 3B is a schematic side sectional view of a variable vane and an alternative embodiment of the variable vane control system of FIG. 2.

FIG. 4 is a block diagram of the variable vane control system of FIG. 2.

### DETAILED DESCRIPTION

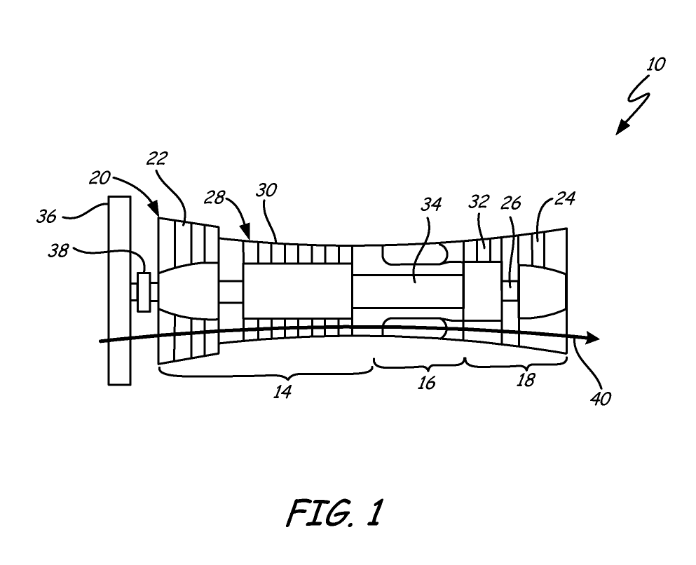

FIG. 1 is a schematic side view of gas turbine engine 10. Gas turbine engine 10 includes compressor section 14, combustor section 16, and turbine section 18. Low pressure spool 20 (which includes low pressure compressor 22 and low pressure turbine 24 connected by low pressure shaft 26) and high pressure spool 28 (which includes high pressure compressor 30 and high pressure turbine 32 connected by high pressure shaft 34) each extend from compressor section 14 to turbine section 18. Propulsion fan 36 is connected to and driven by low pressure spool 20. A fan drive gear system 38 may be included between the propulsion fan 36 and low pressure spool 20. Air flows from compressor section 14 to turbine section 18 along engine gas flow path 40. In alternative embodiments, gas turbine engine 10 can be of a type different than that illustrated with respect to FIG. 1, such as a turboprop engine or an industrial gas turbine engine. The general construction and operation of gas turbine engines is well-known in the art, and therefore detailed discussion here is unnecessary.

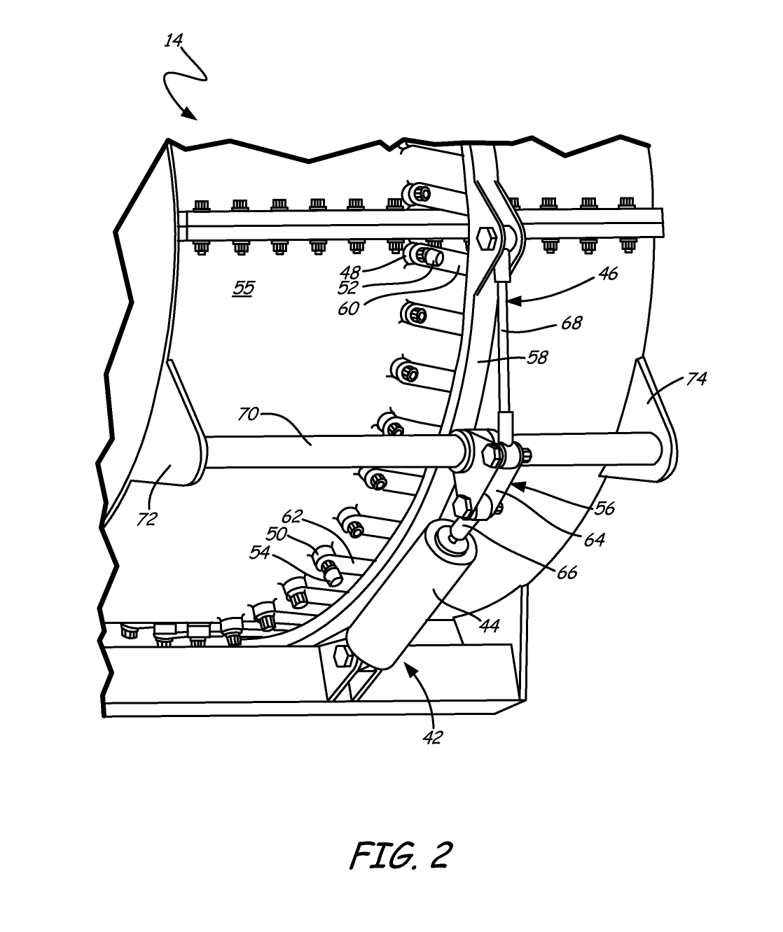

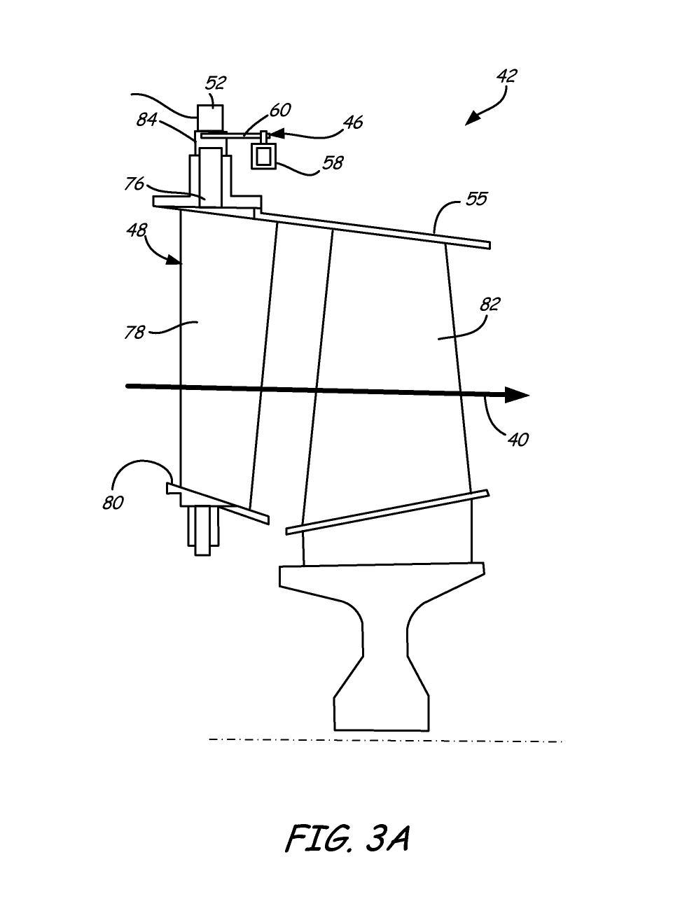

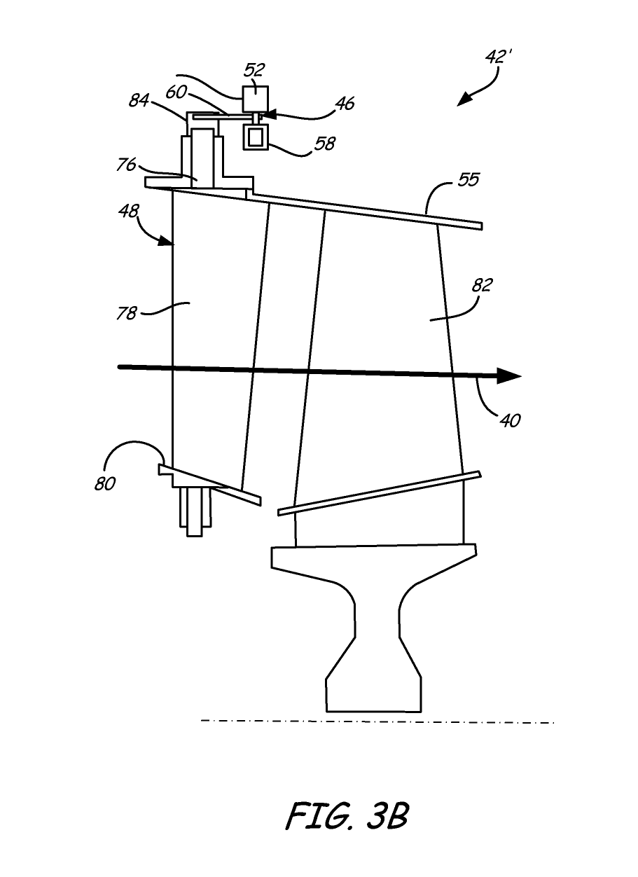

FIG. 2 is a perspective view of a portion of compressor section 14 including variable vane control system 42, which includes actuator 44, mechanical linkage assembly 46, variable vanes 48 and 50, and vane position sensors 52 and 54. Variable vanes 48 and 50 extend partially through case 55 of compressor section 14, as further described with respect to FIGS. 3A and 3B. Mechanical linkage assembly 46 includes torque converter 56, unison ring 58, and vane arms 60 and 62. In the illustrated embodiment, torque converter 56 includes crank 64 connected to actuator 44 via shaft 66 and connected to unison ring 58 via shaft 68. Torque converter 56 pivots on shaft 70, which extends between supports 72 and 74. In alternative embodiments, torque converter 56 can be another type of torque converter that functions to increase torque.

Unison ring 58 is connected to variable vanes 48 and 50 via vane arms 60 and 62. In the illustrated embodiment, variable vanes 48 and 50 are two of a plurality of variable vanes and vane arms 60 and 62 are two of a plurality of vane arms, each connected to unison ring 58. In alternative embodiments, actuator 44 can be connected to variable vane 48 and/or variable vane 50 without use of unison ring 58.

Vane position sensors 52 and 54 are connected to mechanical linkage assembly 46 between torque converter 56 and variable vanes 48 and 50, respectively, for sensing angular position of variable vanes 48 and 50. In the illustrated embodiment, vane position sensors 52 and 54 are fixedly attached to variable vanes 48 and 50. In an alternative embodiment, one or more of vane position sensors 52 and 54 can be connected to mechanical linkage assembly 46 between unison ring 58 and variable vanes 48 and 50, respectively, though not necessarily fixedly attached to variable vanes 48 and 50. In a further alternative embodiment, gas turbine engine 10 can include anywhere from one to four vane position sensors per unison ring. In a further alternative embodiment, each of the plurality of variable vanes can have a corresponding vane position sensor.

FIG. 3A is a schematic side sectional view of variable vane 48 and variable vane control system 42. Variable vane 48 includes vane stem 76 and vane airfoil 78. Vane airfoil 78 extends across gas flow path 40 between case 55 and inner diameter platform 80. Vane stem 76 extends from vane airfoil 78 through case 55 to connect to mechanical linkage assembly 46. Variable vane 48 can be an inlet guide vane, a variable stator vane, or virtually any variable vane that benefits from accurate sensing of angular position. Downstream of variable vane 48 is compressor blade 82. FIG. 3A shows vane arm 60 being connected to vane stem 76 via bracket 84. Bracket 84 is fixedly attached to vane stem 76 via a stud or bolt (not shown). Vane position sensor 52 is mounted on and fixedly connected to bracket 84, and consequently, is fixedly attached to vane stem 76 so as to rotate with variable vane 48. In an alternative embodiment, vane arm 60 can be connected to vane stem 76 without use of bracket 84. Similarly, vane position sensor 52 can be connected to vane stem 76 without use of bracket 84. In further alternative embodiments, vane position sensor 52 can include multiple parts with only part of vane position sensor 52 being fixedly connected to bracket 84 and/or vane stem 76.

Vane position sensor 52 is a contact type position sensor for determining angular position of variable vane 48 as variable vane 48 rotates. In some embodiments, vane position sensor 52 can be a magnetic sensor, such as a Hall effect sensor, a giant magnetoresistance (GMR) sensor, a colossal magnetoresistance (CMR) sensor, or an anisotropic magnetoresistance (AMR) sensor. In the illustrated embodiment, vane position sensor 52 is a Hall effect sensor having a magnet positioned on vane stem 76 to rotate with variable vane 48. In alternative embodiments, vane position sensor 52 can be a contact type sensor suitable for the application other than a magnetic sensor.

FIG. 3B is a schematic side sectional view of variable vane 48 and variable vane control system 42′. Variable vane control system 42′ is similar to variable vane control system 42 (shown in FIGS. 2 and 3A) except that vane position sensor 52 is connected to vane arm 60 near unison ring 58. Thus, vane position sensor 52 is on a portion of mechanical linkage assembly 46 proximate variable vane 48. In an alternative embodiment, vane position sensor 52 can be integrated with an element of variable vane 48 or mechanical linkage assembly 46. In further alternative embodiments, vane position sensor 52 can include multiple parts with only part of vane position sensor 52 being connected to or integrated with vane arm 60 or another element of mechanical linkage assembly 46.

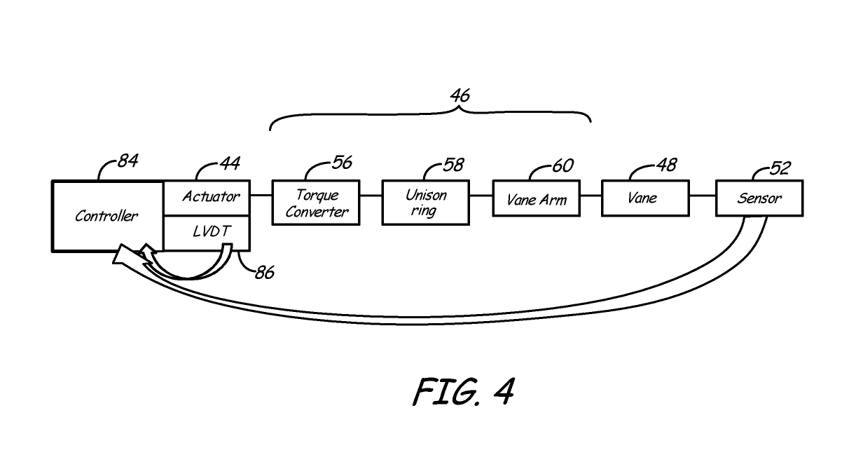

FIG. 4 is a block diagram of variable vane control system 46, showing actuator 44 connected to torque converter 56, which is connected to unison ring 58, which is connected to vane arm 60, which is connected to variable vane 48, which is connected to vane position sensor 52. Actuator position sensor 86 is connected to actuator 44 for sensing position of actuator 44. In the illustrated embodiment, actuator position sensor 86 is a linear variable differential transformer (LVDT) integrated with actuator 44. Controller 84 is connected to and controls actuator 44.

In operation, controller 84 signals actuator 44 to actuate variable vane 48. Actuator 44 responds by actuating torque converter 56, which moves unison ring 58 and consequently moves vane arm 60 to rotate variable vane 48. Vane position sensor 52 sends a vane position signal representing sensed angular position of variable vane 48 to controller 84. Actuator position sensor 86 sends an actuator position signal representing sensed position of actuator 44 to controller 84. Using both the vane position signal and the actuator position signal, controller 84 can determine whether variable vane 48 is positioned correctly or if the angular position of variable vane 48 should be adjusted. Thus, angular position of variable vane 48 can be adjusted based on the position signal from vane position sensor 52. In an alternative embodiment, controller 84 can determine position of variable vane 48 using the vane position signal from vane position sensor 52, without using an actuator position signal from actuator positions sensor 86. In a further alternative embodiment, controller 84 can control actuator 44 using a combination of a first vane position signal from vane position sensor 52 and a second vane position signal from vane position sensor 54 (shown in FIG. 2).

Variable vane control systems 42 and 42′, as described above, can provide relatively precise control of variable vane position which can yield several potential benefits and advantages, including: improved stability margin and choke, better fuel burn efficiency, potential reduction in the number of compressor stages, and potential reduction in incidence of variable vane breakage. Variable vane control systems 42 and 42′ can be relatively durable, reliable, accurate, and cost-effective.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims. For example, vane control systems 42 and 42′ can include one or more additional actuators and/or unison rings. Moreover, construction of vane control systems 42 and 42′ can be further varied so long as vane position sensor 52 is connected to either variable vane 48 or mechanical linkage assembly 46 sufficiently proximate to variable vane 48 so as to allow for suitable sensing of angular position of variable vane 48.

1. A variable vane control system for use with a gas turbine engine having a plurality of variable vanes each with an airfoil disposed in a gas flow path of the gas turbine engine, wherein the plurality of variable vanes includes a first variable vane, the system comprising:
an actuator;
a mechanical linkage assembly for operably connecting the actuator to at least the first variable vane; and
a vane position sensor connected to one of the first variable vane or a portion of the mechanical linkage assembly proximate the first variable vane for sensing angular position of the first variable vane.

2. The system of claim 1, wherein the mechanical linkage assembly includes a torque converter, and wherein the vane position sensor is positioned on the mechanical linkage assembly between the torque converter and the first variable vane.

3. The system of claim 1, wherein the vane position sensor is fixedly attached to the first variable vane.

4. The system of claim 1, wherein the vane position sensor is positioned on a stem of the variable vane so as to rotate with the first variable vane.

5. The system of claim 1, wherein the vane position sensor is a magnetic sensor.

6. The system of claim 1, and further comprising:
an actuator position sensor connected to the actuator for sensing position of the actuator.

7. The system of claim 6, and further comprising:
a controller connected to the actuator, the vane position sensor, and the actuator position sensor for controlling the actuator based on signals from both the vane position sensor and the actuator position sensor.

8. The system of claim 1, and further comprising:
a controller connected to the actuator and the vane position sensor for controlling the actuator based on signals from the vane position sensor.

9. A variable vane control system for use with a gas turbine engine having a plurality of variable vanes each with an airfoil disposed in a gas flow path of the gas turbine engine, wherein the plurality of variable vanes includes a first variable vane, the system comprising:
an actuator;
a mechanical linkage assembly for operably connecting the actuator to at least one of the plurality of vanes, wherein the mechanical linkage assembly includes a torque converter; and
a vane position sensor connected to the mechanical linkage assembly between the torque converter and the first variable vane for sensing angular position of the first variable vane.

10. The system of claim 9, wherein the mechanical linkage assembly includes a unison ring, wherein the unison ring is connected to the actuator via the torque converter, wherein the unison ring is connected to the plurality of variable vanes via a plurality of vane arms.

11. The system of claim 10, wherein the vane position sensor is positioned on the mechanical linkage assembly between the unison ring and the first variable vane.

12. The system of claim 11, wherein the plurality of variable vanes includes a second variable vane, wherein the vane position sensor is a first vane position sensor, and further comprising:
a second vane position sensor positioned on the mechanical linkage assembly between the unison ring and the second variable vane for sensing angular position of the second variable vane.

13. The system of claim 9, wherein the vane position sensor is fixedly attached to the first variable vane.

14. The system of claim 9, wherein the vane position sensor is positioned on a stem of the variable vane so as to rotate with the first variable vane.

15. The system of claim 9, wherein the vane position sensor is a magnetic sensor.

16. The system of claim 15, wherein the vane position sensor comprises a sensor selected from the group consisting of a Hall effect sensor, a giant magnetoresistance (GMR) sensor, a colossal magnetoresistance (CMR) sensor, or an anisotropic magnetoresistance (AMR) sensor.

17. The system of claim 9, and further comprising:
an actuator position sensor connected to the actuator for sensing position of the actuator.

18. The system of claim 17, and further comprising:
a controller connected to the actuator, the vane position sensor, and the actuator position sensor for controlling the actuator based on signals from both the vane position sensor and the actuator position sensor.

19. The system of claim 9, and further comprising:
a controller connected to the actuator and the vane position sensor for controlling the actuator based on signals from the vane position sensor.

20. A method for operating a variable vane control system for use with a gas turbine engine, the method comprising:
rotating a first variable vane via an actuator mechanically connected to the first variable vane;
sensing angular position of the first variable vane via a vane position sensor fixedly attached to the first variable vane; and
adjusting angular position of the first variable vane based on a position signal from the vane position sensor representing sensed angular position of the first variable vane.
